(19) United States
(12) Patent Application Publication
(10) Pub. No.: US 2018/0132234 A1
(43) Pub. Date: May 10, 2018

(54) ENHANCED WIRELESS NETWORKS FOR TIME SENSITIVE APPLICATIONS

(71) Applicants: Dave CAVALCANTI, Beaverton, OR (US); Carlos CORDEIRO, Portland, OR (US)

(72) Inventors: Dave CAVALCANTI, Beaverton, OR (US); Carlos CORDEIRO, Portland, OR (US)

(21) Appl. No.: 15/347,447

(22) Filed: Nov. 9, 2016

(51) Int. Cl. H04W 72/04; H04W 74/00; H04W 74/02

(52) U.S. Cl. CPC H04W 72/0446; H04W 74/02; H04W 74/004

(57) ABSTRACT

This disclosure describes systems, methods, and apparatus related to wireless time sensitive networking. A device may determine one or more communication channels. The device may assign a first communication channel of the one or more communication channels, for time sensitive networking. The device may cause to send a frame including an indication of the first communication channel to one or more devices. The device may identify a time sensitive networking channel access request from a first device. The device may determine the first device is authorized to access the first communication channel.

### TECHNICAL FIELD

This disclosure generally relates to systems, methods, and devices for wireless communications and, more particularly, enhancing wireless networks for time sensitive applications.

### BACKGROUND

Time sensitive networking (TSN) includes networks that provide time synchronization and timeliness, with focus on deterministic latency and reliability/redundancy to critical data flows. Traditionally TSN applications have been using wired connectivity. However, wiring has several limitations, such as, high maintenance cost, weight, or limited mobility.

### BRIEF DESCRIPTION OF THE DRAWINGS

FIG. 1 depicts a diagram illustrating an example network environment for an illustrative wireless TSN (WTSN) system, in accordance with one or more example embodiments of the present disclosure.

FIG. 2 depicts an illustrative schematic diagram of a synchronized TSN message flow, in accordance with one or more example embodiments of the present disclosure.

FIG. 3 depicts an illustrative schematic channel allocation for TSN and non-TSN data exchanges, in accordance with one or more example embodiments of the present disclosure.

FIG. 4 depicts an illustrative schematic IE structure associated with TSN announcements, in accordance with one or more example embodiments of the present disclosure.

FIG. 5A depicts a flow diagram of an illustrative process for an illustrative WTSN system, in accordance with one or more example embodiments of the present disclosure.

FIG. 5B depicts a flow diagram of an illustrative process for an illustrative WTSN system, in accordance with one or more example embodiments of the present disclosure.

FIG. 6 illustrates a functional diagram of an example communication station that may be suitable for use as a user device, in accordance with one or more example embodiments of the present disclosure.

FIG. 7 illustrates a block diagram of an example machine upon which any of one or more techniques (e.g., methods) may be performed, in accordance with one or more example embodiments of the present disclosure.

### DETAILED DESCRIPTION

Example embodiments described herein provide certain systems, methods, and devices, for providing messaging to wireless devices in various wireless networks, including but not limited to Wi-Fi, TSN, Wireless USB, Wi-Fi peer-to-peer (P2P), Bluetooth, NFC, or any other communication standard.

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some communications require reliable and deterministic communications between devices. One example may be what is known as TSN. TSN applications require very low and bounded transmission latency and high availability. TSN applications include a mix of traffic patterns and requirements. In one example, synchronous TSN data flows (e.g., between sensors, actuators and controllers in a closed loop control system) require even more reliable and deterministic communications. Some TSN flows require latencies about 10's of μs with high reliability. During these communications, one or more TSN flows may be generated in order to send and receive data between devices. For example, each TSN flow generates a synchronous data stream with a fixed packet size and inter-arrival period. Typically, these types of applications were carried in a wired network.

A wireless solution for TSN applications may include Wi-Fi as a potential candidate to enable wireless TSN applications. A benefit of Wi-Fi as a medium for wireless TSN applications is that Wi-Fi communications are carried out in unlicensed spectrum, with low deployment costs. However, the unlicensed spectrum also imposes challenges, especially to guarantee reliabilities and latencies comparable to wired protocols (e.g., Ethernet TSN).

Wi-Fi operation is defined across a range of frequency bands including 2.4 GHz, 5 GHz, and 60 GHz. A pre-defined number of channels are allocated in each band. For instance, 21 non-overlapping 20 MHz channels in the 5 GHz band, and 4 non-overlapping 2.16 GHz channels in the 60 GHz band. The selection of the operating channel within the available set for a given IEEE 802.11 mode (e.g. IEEE 802.11n, IEEE 802.11ac, or IEEE 802.11ad) is implementation dependent. Each access point (AP) may select its operating channel and no coordination is required with other APs or stations (STAs).

Once a channel is selected, all associated STAs with a given AP can access the channel in accordance with medium access control (MAC) protocol rules. STAs may also independently decide to transmit in any given channel. For instance, a STA may switch to a channel to transmit probe request frames to discover networks in the vicinity. Furthermore, there is no restriction on the type of application traffic that can use a Wi-Fi channel. While there are QoS mechanisms to enable priority access (e.g., IEEE 802.11e) and scheduled access mode (e.g., scheduled MAC in 802.11ad), there are no practical mechanisms to restrict the type of application traffic that can use a certain channel.

Example embodiments of the present disclosure relate to systems, methods, and devices for enhancing wireless networks for time sensitive applications.

In one embodiment, a WTSN system may restrict wireless devices from accessing a dedicated channel based at least in part on the type of application.

In one embodiment, a WTSN system may enable an AP to assign dedicated channel(s) to TSN applications including announcement of TSN dedicated channels and a procedure to prevent non-TSN transmissions in TSN dedicated channels. The AP may select a dedicated channel for TSN transmissions based on a combination of factors. Some of these factors may include channel measurements, the number of associated STAs, specific latency and reliability requirements.

In one embodiment, a WTSN system may define one or more access rules associated with dedicated channels. These one or more rules may be shared with the TSN devices and other wireless devices.

In one embodiment, a WTSN system may enable an AP to advertise the assigned dedicated channels to one or more devices including a mix of TSN devices and wireless devices.

In one embodiment, a WTSN system may define an information element to be used in management frames, such as beacon frames, announce frames, trigger frames, or any other management frame. The information element may include TSN specific information.

Given the deterministic nature of the most critical TSN flows (both packet size and inter-arrival times are known), by restricting access to a given channel to only TSN flows, it becomes possible to schedule TSN transmissions, provide redundancy, and avoid interference from other STAs.

The above descriptions are for purposes of illustration and are not meant to be limiting. Numerous other examples, configurations, processes, etc., may exist, some of which are described in detail below. Example embodiments will now be described with reference to the accompanying figures.

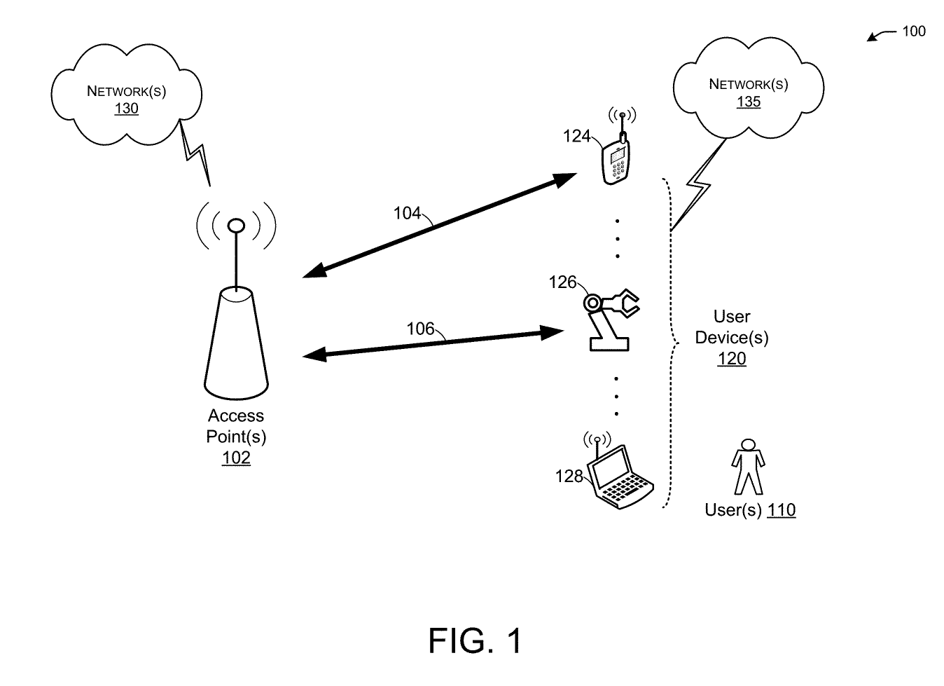

FIG. 1 is a diagram illustrating an example network environment, in accordance with one or more example embodiments of the present disclosure. Wireless network 100 may include one or more user devices 120 and one or more access point(s) (AP) 102, which may communicate in accordance with and compliant with various communication standards and protocols, such as, Wi-Fi, TSN, Wireless USB, P2P, Bluetooth, NFC, or any other communication standard. The user device(s) 120 may be mobile devices that are non-stationary (e.g., not having fixed locations) or may be stationary devices.

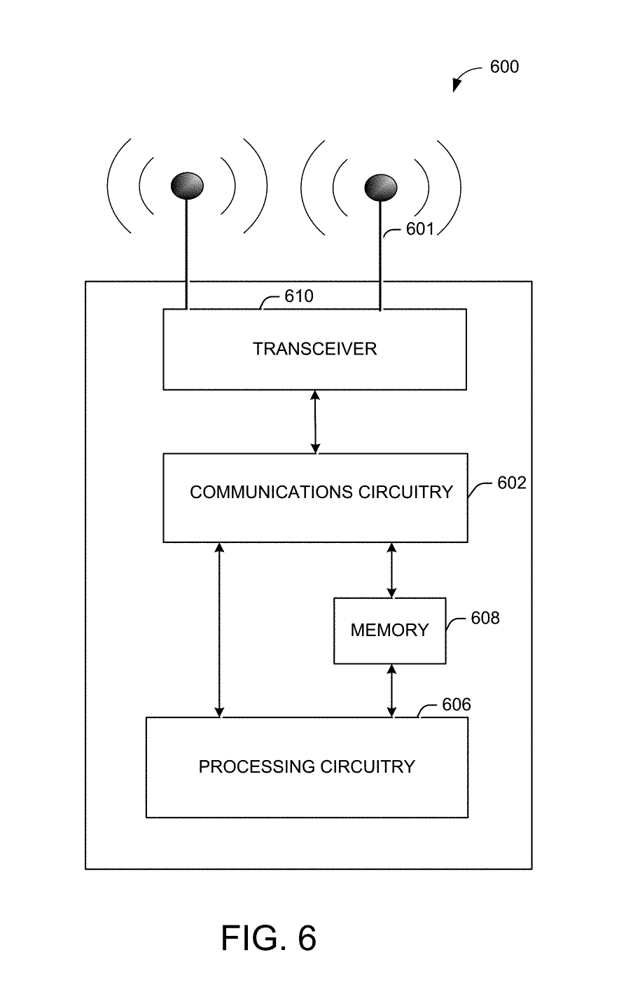

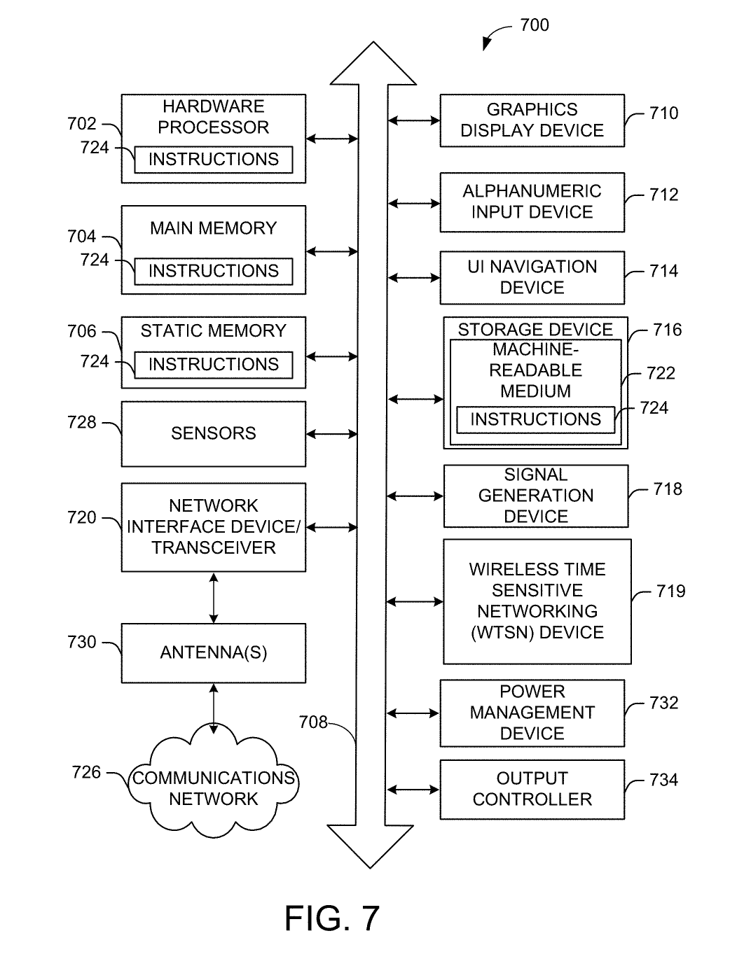

In some embodiments, the user devices 120 and AP 102 may include one or more computer systems similar to that of the functional diagram of FIG. 6 and/or the example machine/system of FIG. 7.

One or more illustrative user device(s) 120 and/or AP 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP 102 may operate as a personal basic service set (PBSS) control point/access point (PCP/AP). The user device(s) 120 (e.g., 124, 126, or 128) and/or AP 102 may include any suitable processor-driven device including, but not limited to, a mobile device or a non-mobile, e.g., a static, device. For example, user device(s) 120 and/or AP 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a robotic device, an actuator, a robotic arm, an industrial robotic device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

Any of the user device(s) 120 (e.g., user devices 124, 126, 128), and AP 102 may be configured to communicate with each other via one or more communications networks 130 and/or 135 wirelessly or wired. The user device(s) 120 may also communicate peer-to-peer or directly with each other with or without the AP 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP 102 may include one or more communications antennas. The one or more communications antennas may be any suitable type of antennas corresponding to the communications protocols used by the user device(s) 120 (e.g., user devices 124, 126 and 128), and AP 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP 102.

Any of the user device(s) 120 (e.g., user devices 124, 126, 128), and AP 102 may be configured to perform directional transmission and/or directional reception in conjunction with wirelessly communicating in a wireless network. Any of the user device(s) 120 (e.g., user devices 124, 126, 128), and AP 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP 102 may be configured to perform any given directional transmission towards one or more defined transmit sectors. Any of the user device(s) 120 (e.g., user devices 124, 126, 128), and AP 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP 102 may be configured to use all or a subset of its one or more communications antennas to perform MIMO beamforming.

Any of the user devices 120 (e.g., user devices 124, 126, 128), and AP 102 may include any suitable radio and/or transceiver for transmitting and/or receiving radio frequency (RF) signals in the bandwidth and/or channels corresponding to the communications protocols utilized by any of the user device(s) 120 and AP 102 to communicate with each other. The radio components may include hardware and/or software to modulate and/or demodulate communications signals according to pre-established transmission protocols. The radio components may further have hardware and/or software instructions to communicate via one or more communication standards and protocols, such as, Wi-Fi, TSN, Wireless USB, Wi-Fi P2P, Bluetooth, NFC, or any other communication standard. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax), or 60 GHZ channels (e.g. 802.11ad). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

When an AP (e.g., AP 102) establishes communication with one or more user devices 120 (e.g., user devices 124, 126, and/or 128), the AP 102 may communicate in a downlink direction and the user devices 120 may communicate with the AP 102 in an uplink direction by sending frames in either direction. The user devices 120 may also communicate peer-to-peer or directly with each other with or without the AP 102. The data frames may be preceded by one or more preambles that may be part of one or more headers. These preambles may be used to allow a device (e.g., AP 102 and/or user devices 120) to detect a new incoming data frame from another device. A preamble may be a signal used in network communications to synchronize transmission timing between two or more devices (e.g., between the APs and user devices).

In one embodiment, and with reference to FIG. 1, an AP 102 may communicate with user devices 120. The user devices 120 may include one or more wireless devices (e.g., user device 124 and user device 128) and one or more wireless TSN devices (e.g., user device 126). The user devices may access a channel in accordance with MAC protocol rules or any other access rules (e.g., Wi-Fi, Bluetooth, NFC, etc.). It should be noted that reserving a dedicated TSN channel and controlling access to it may also be applicable to cellular systems/3GPP networks, such as LTE, 5G, or any other wireless networks. The wireless TSN devices may also access a channel according to the same or modified protocol rules. However, the AP 102 may dedicate certain channels (e.g., channel 106) for TSN applications that may be needed by the one or more wireless TSN devices and may allocate other channels (e.g., channel 104) for the non-TSN devices (e.g., user device 124 and user device 128). The AP 102 may also define one or more access rules associated with the dedicated channels. The channel 104 may be dedicated for TSN transmissions for TSN applications by TSN devices. For example, user device 126 may access the channel 106 for TSN transmissions. TSN transmissions may include transmissions that have very low transmission latency and high availability requirements. Further, the TSN transmissions may include synchronous TSN data flows between sensors, actuators, controllers, robots, in a closed loop control system. The TSN transmissions require reliable and deterministic communications. The channel 106 may be accessed by the user device 126 for a number of TSN message flows and is not limited to only one TSN message flow. The TSN message flows may depend on the type of application messages that are being transmitted between the AP 102 and the user device 126. It is understood that the above descriptions are for purposes of illustration and are not meant to be limiting.

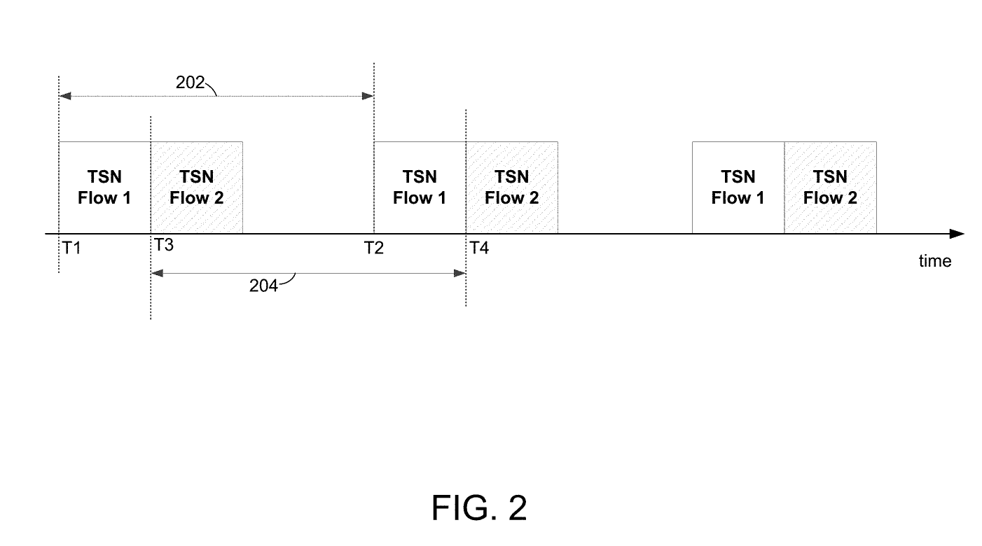

FIG. 2 depicts an illustrative schematic diagram of a synchronized TSN message flow, in accordance with one or more example embodiments of the present disclosure.

A TSN message flow may be implemented in a fast control loop. The TSN message flow may consist of a stream of fixed size packets to be delivered with high reliability, in which a constant packet inter-arrival interval is defined by the control cycle latency. Multiple TSN flows may be active simultaneously, as well as other non-TSN applications in the same area (e.g., manufacturing floor). Any non-TSN transmission that takes longer than the control cycle latency would delay a TSN packet, which is not desirable.

Referring to FIG. 2, there is shown two TSN message flows, TSN flow 1 and TSN flow 2. These two flows represent synchronized TSN flows having control cycle latency between each packet within the same flow. For example, a control cycle latency 202 may be defined as the time interval between time T1 and T2 for TSN flow 1, and another control cycle latency 204 may be defined as the time interval between T3 and T4 for TSN flow 2. This basically shows that the packets in a TSN flow have constant packet sizes and constant inter-arrival time of these packets with time synchronized TSN flows.

Existing scheduled-based wireless protocols enable service period (SP) reservations for reserved traffic while contention-based periods can be used for other traffic. However, depending on the control cycle latency requirements, the amount of time left for other applications and management frame exchanges in contention-based mode would be very limited. That is, TSN flows may require larger timeslots or frequency allocation to accommodate for TSN applications. The TSN flows would leave little room for other devices attempting to communicate with an AP or other devices using the existing scheduled-based wireless protocols.

Using Wi-Fi networks as an example, in the current Wi-Fi networks (2.4/5/60 GHz), it may not be possible to support TSN applications with deterministic latencies (as low as 10's of μs) while also supporting non-TSN traffic in a shared channel. In other words, current Wi-Fi networks are not able to provide deterministic access and latency guarantees for constant packet sizes and constant arrival times of packets in a TSN flow while enabling contention with non-TSN STA in the same channel.

In one embodiment, a WTSN system may enable an AP to assign specific channels for TSN applications in order to prevent interference from non-TSN STAs and guarantee bounded latency and high reliability. It is understood that the above descriptions are for purposes of illustration and are not meant to be limiting.

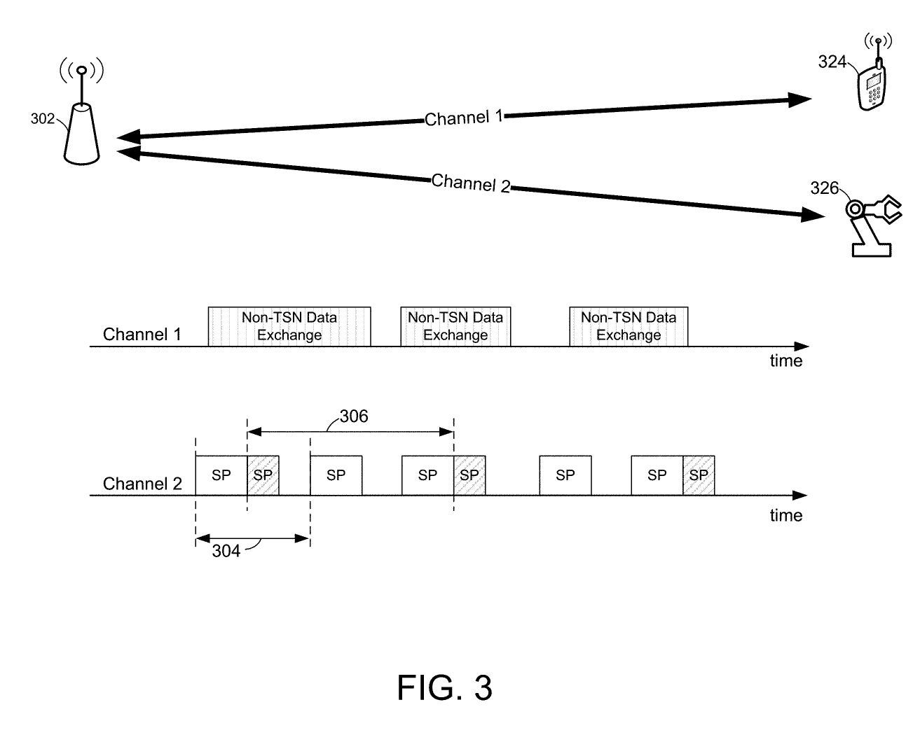

FIG. 3 depicts an illustrative schematic channel allocation for TSN and non-TSN data exchanges, in accordance with one or more example embodiments of the present disclosure.

In this example, an AP 302 may be communicating with one or more user devices (e.g., user device 324 and user device 326).

In one embodiment, a WTSN system may include TSN capable devices (e.g., user device 326) and non-TSN type devices (e.g., user device 324). The user device 324 may be a wireless device that does not require TSN transmissions and may perform non-TSN data exchange with the AP 302. The user device 326 may be a device that required TSN transmissions with the AP 302. These TSN transmissions may operate in a time synchronized packet exchange flow with the AP 302.

The TSN transmissions on channel 2 may include two TSN flows: TSN flow 1 and TSN flow 2. These two flows represent synchronized TSN flows having a control cycle latency between each packet within the same flow. For example, a control cycle latency 304 may be defined between two consecutive service periods (SPs) for TSN flow 1, and another control cycle latency 306 may be defined between two consecutive SPs for TSN flow 2. This basically shows that the packets in a TSN flow have constant packet sizes and constant inter-arrival time of these packets with time synchronized TSN flows.

In one embodiment, it may be assumed that a WTSN system may be established in a managed wireless network (e.g., managed Bluetooth network, managed NFC network, managed Wi-Fi network, or any other managed wireless network). This assumption may be reasonable because most industrial and enterprise environments where TSN applications may be used are established as managed wireless networks.

In one embodiment, a user device with TSN flows may request access from an AP (e.g., AP 302) using certain quality of service (QoS) requirements or traffic requirements specifications (TSPEC). Further, a user device with TSN flows may identify to the AP that it has TSN data to be transmitted. One mechanism to notify the AP of these TSN transmissions is to use a TSPEC frame. A TSPEC frame allows a Wi-Fi device to signal its traffic requirements to the AP. The TSPEC frame may include data rate, packet size, number of streams, and other information. In a WTSN system, the TSN device may additionally include information associated with the TSN flows in the TSPEC frame.

In one embodiment, a WTSN system may enable an AP (e.g., AP 302) to select one or more Wi-Fi channels (e.g., channel 2) for TSN applications. The selection and configuration of the TSN channel(s) may be done statically at the network deployment/configuration time. That is, a network administrator, and operator, or the WTSN system may select specific channels to be dedicated for TSN applications, at the time the AP is deployed in a network or added time when the AP is configured for operations. However, in other embodiments, a WTSN system may dynamically select and dedicate one or more specific channels for TSN applications based on channel access requests and system load.

In some embodiments, a WTSN system may facilitate an AP to be pre-configured to operate only in the TSN dedicated channels. That is, the AP may restrict access to any non-TSN transmissions on all of its channels. In that scenario, all channels of communication may be dedicated for TSN transmissions.

In one embodiment, a WTSN system may enable an AP to select and dedicate additional TSN channels after the AP already dedicated one or more TSN channels. It should be noted that it may be also possible that the AP may decide to dedicate a TSN channel after it started operating in a regular non-TSN channel. For instance, the AP may decide to reserve one or more channels for TSN applications based on requests associated with TSN transmissions from various devices. Alternatively, the AP may dynamically assign TSN channels for TSN transmissions based on, for example, load between TSN and non-TSN traffic or any other factors.

In another embodiment, a WTSN system may determine that a dedicated TSN channel may only be used by synchronous TSN flows, whose characteristics are known by the AP. For example, devices requesting channel access from the AP may provide information associated with the requested flows during association or admission control processes. All the other traffic may be transmitted in a regular (non-TSN channel). It should be appreciated that association is mechanism to allow a STA to access a network through an AP. APs may be devices that bridge traffic between STAs and other devices on the network and also control access to the network for communication between devices. Before a STA can send traffic through an AP or in the channel/network controlled by the AP, it must be in the appropriate connection state. The STA and AP may exchange a series of IEEE 802.11 management frames in order to get to an authenticated and associated state. In the same token, admission control may be used to balance the goals of maximizing bandwidth utilization and ensuring sufficient resources for high priority events. The purpose of admission control is to limit the amount of traffic admitted into a particular service class so that the QoS of the existing flows will not be degraded while at the same time the medium resources can be maximally utilized.

It should be appreciated that in order to enable simultaneous operation in multiple channels, the AP may need to be equipped with multiple radios.

In one embodiment, a WTSN system may select a particular channel(s) to be dedicated for TSN applications using a combination of factors, including but not limited to, channel measurements, number of associated STAs, specific latency requirements, or any other network factors. For example, a signal to noise ratio (SNR) and a received signal strength indicator (RSSI) may determine whether a channel is suitable for TSN applications. Further, the AP may select a channel to be dedicated for TSN applications based on the number of STAs requesting access to a channel from the AP. For example, if there is a large number STAs requesting channel access for TSN applications, the AP may dedicate additional channels for TSN applications.

In one embodiment, in order to enable TSN dedicated channels, the AP may advertise a TSN channel announcement of the channels that are reserved for TSN applications. The AP may utilize beacon frames and other control and/or management frames (e.g., announce frames, trigger frames, or any other frames). These frames may carry a list of channels that are dedicated for TSN. For example, AP 302 may advertise to user devices 324 and 326 that channel 2 is dedicated for TSN transmissions. The TSN channel announcement may include specific PHY and MAC operational parameters that define operation on such channels, including, but not limited to, modulation and coding scheme (MCS), data rates, power levels, access parameters, etc. It is understood that the above descriptions are for purposes of illustration and are not meant to be limiting.

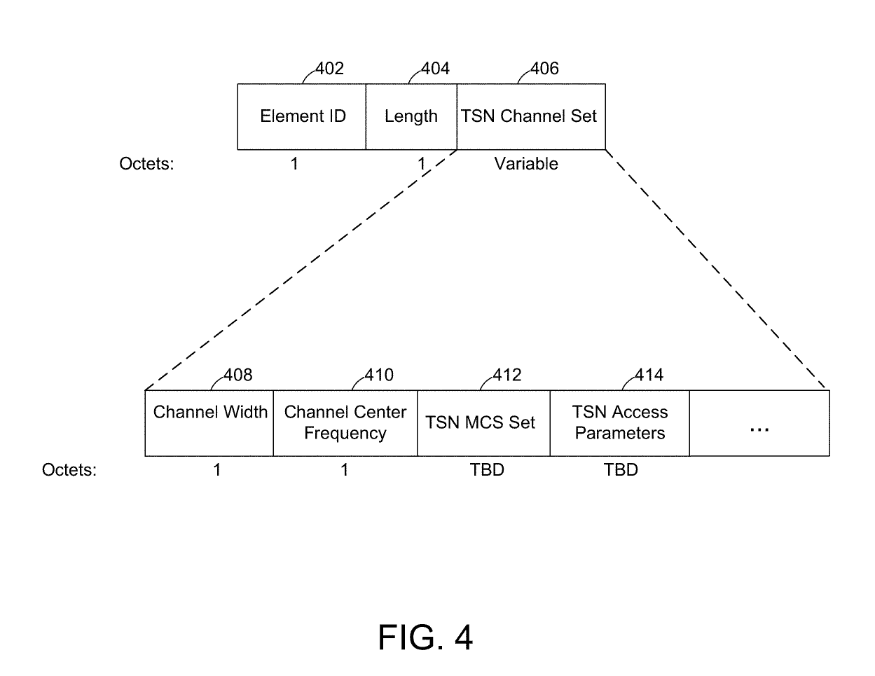

FIG. 4 depicts an illustrative schematic IE structure associated with TSN announcements, in accordance with one or more example embodiments of the present disclosure.

Referring to FIG. 4, there is shown a new TSN channel set IE. The TSN channel set IE may be defined to be included in one or more control/management frames. For example, the TSN channel set IE may be included in beacon frames and carried in a beacon frame body to provide operational information for each channel dedicated for TSN transmission. It is understood that a beacon frame is one of the management frames in IEEE 802.11 based WLANs. The beacon frame may contain information about the network. Beacon frames may be transmitted periodically to announce the presence of a wireless LAN. Beacon frames may be transmitted by the AP in an infrastructure basic service set (BSS). In an IBSS network, beacon generation may be distributed among the STAs. The TSN channel set IE may include, in element ID field 402, a length field 404, and a TSN channel set field 406.

The TSN channel set field 406 may include one or more TSN channel operational information fields. Each of the TSN channel operational information fields may include, at least in part, a channel width field 408, a channel center frequency field 410, a TSN MCS set field 412, and a TSN access parameters field 414.

In one embodiment, the TSN MCS set field 412 may include the set of MCSs and spatial streams that may be used for TSN transmissions in a dedicated channel. That is, the AP may utilize the TSN MCS set field 412 to announce to the STAs the set of MCSs and spatial streams in case the STAs have TSN data packets to transmit.

The TSN access parameters field 414 may include at least in part specific MAC access mode. The MAC access modes may include but not limited to, a scheduled mode where the AP assigns one or more time (or frequency) slots to be used by one or more devices, a contention mode, where the AP does not assign one or more time (or frequency) slots for one or more devices. Instead, the time or frequency slots are taken by contention based mechanism. Further, the MAC access mode may include a polled mode, where the AP may send a poll request inquiring if the user device has data to send in the uplink direction.

In one embodiment, STAs may also be pre-configured with TSN dedicated channels. That is STAs are aware of certain TSN dedicated channels, which are preconfigured on the STAs even before being assigned by the AP. Furthermore, STAs may not transmit on dedicated TSN channels unless authorized by the AP. If a STA has no pre-configured dedicated TSN channels, the STA may detect if the AP supports dedicated TSN channels by decoding the dedicated TSN channel operational information in a beacon frame. If the STA identifies that the AP supports dedicated TSN channel, the STA may not transmit on such channels unless authorized by the AP. The AP may determine based on a channel access request received from a STA whether to allow the STA to transmit data on a TSN channel. For example the STA may utilize the operational information included in the IE that includes the TSN channel set field. The STA may further notify/inform the AP that the STA has TSN transmissions. The STA may use an operational non-TSN channel in order to notify/inform the AP that the STA needs TSN service support, and that it has TSN transmissions. The AP may utilize the information received from the STA in order to determine whether to allow the STA to utilize the dedicated TSN channel based at least in part on the information received from the STA. If the AP determines that the STA is allowed to access the TSN channel, the AP may communicate with the STA using the dedicated TSN channel. However, if the AP determines that the STA is not allowed or authorized to access the TSN channel, the AP may assign a non-TSN channel to communicate with the STA.

In another embodiment, if the STA requires TSN-grade services it may execute an admission control procedure to request access to the TSN dedicated channels.

In one embodiment a TSN dedicated channel may be assigned only for synchronous TSN flows. Other non-synchronous data may still use the regular (non-TSN) channel. It is understood that the above descriptions are for purposes of illustration and are not meant to be limiting.

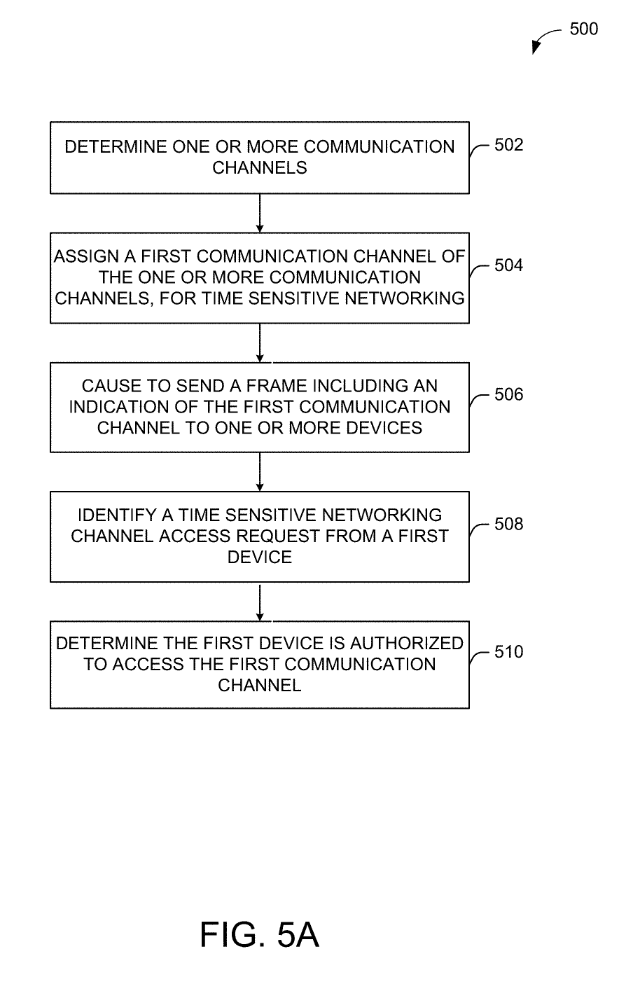

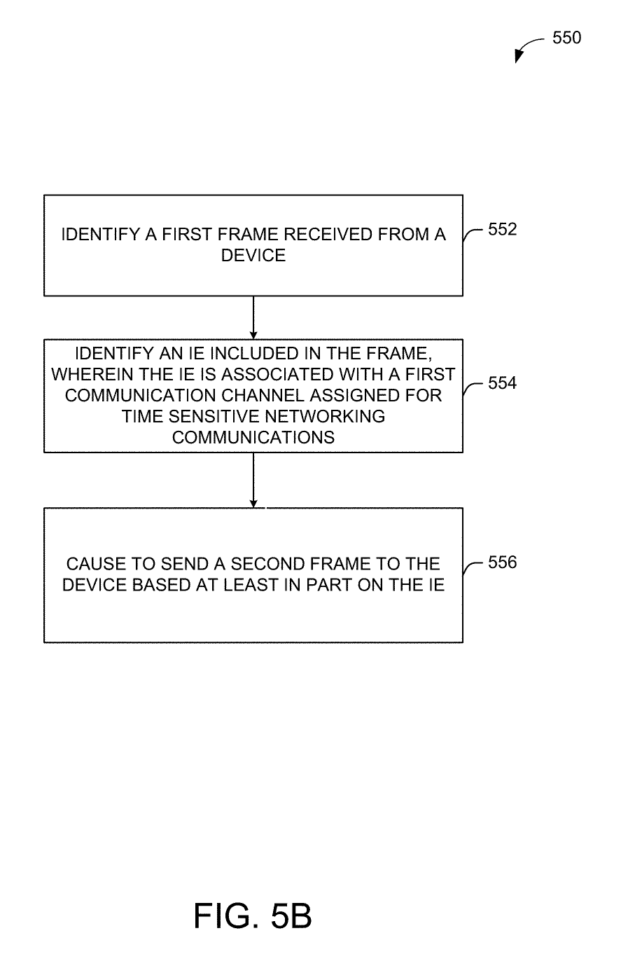

FIG. 5A illustrates a flow diagram of illustrative process 500 for an illustrative WTSN system, in accordance with one or more example embodiments of the present disclosure.

At block 502, a device (e.g., the user device(s) 120 and/or the AP 102 of FIG. 1) may determine one or more communication channels. For example, an AP may establish one or more communication channels with a user device in order to send and receive data packets. The communication channels may be in accordance with one or more wireless standards, such as, Wi-Fi, TSN, Wireless USB, Wi-Fi peer-to-peer (P2P), Bluetooth, NFC, or any other communication standard.

At block 504, the device may assign a first communication channel of the one or more communication channels, for TSN. TSN includes networks that provide time synchronization and timeliness, with focus on deterministic latency and reliability/redundancy to critical data flows. TSN applications include a mix of traffic patterns and requirements. In one example, synchronous TSN data flows (e.g., between sensors, actuators and controllers in a closed loop control system) require even more reliable and deterministic communications. Some TSN flows require latencies about 10's of μs with high reliability. During these communications, one or more TSN flows may be generated in order to send and receive data between devices. For example, each TSN flow generates a synchronous data stream with a fixed packet size and inter-arrival period.

At block 506, the device may cause to send a frame including an indication of the first communication channel to one or more devices. For example, the AP may send an indication to the user device using management frames. The indication may include an IE associated with the first communication channel that is dedicated for TSN. For example, the AP may utilize beacon frames and other control and/or management frames (e.g., announce frames, trigger frames, or any other frames). These frames may carry a list of channels that are dedicated for TSN. For example, the AP may advertise to the user device that a specific channel (or channels) is dedicated for TSN transmissions. The IE may include at least in part, a TSN channel set field. For example, The TSN channel set field may include one or more TSN channel operational information fields. Each of the TSN channel operational information fields may include, at least in part, a channel width field, a channel center frequency field, a TSN MCS set field, and a TSN access parameters field. The TSN MCS set field may include the set of MCSs and spatial streams that may be used for TSN transmissions in a dedicated channel. That is, the AP may utilize the TSN MCS set field to announce to the STAs the set of MCSs and spatial streams in case the STAs have TSN data packets to transmit. The STAs would utilize that information when requesting access to the channel for TSN transmissions. The TSN access parameters field may include at least in part specific MAC access mode. The MAC access modes may include but not limited to, a scheduled mode where the AP assigns one or more time (or frequency) slots to be used by one or more devices, a contention mode, where the AP does not assign one or more time (or frequency) slots for one or more devices. Instead, the time or frequency slots are taken by contention based mechanism. Further, the MAC access mode may include a polled mode, where the AP may send a poll request inquiring if the user device has data to send in the uplink direction.

At block 508, the device may identify a TSN channel access request from a first device. For example, a user device may send a request to access a specific channel, such as a TSN channel that may have been advertised in a beacon frame. The user device may utilize the operational parameters that were included in the IE including the TSN channel set field in order to send the TSN channel access request. It should be noted that the TSN channel access request do not interfere with ongoing TSN flows in the TSN channel. Therefore the AP may also announce in the TSN IE specific resource (time and/or frequency) allocations for devices to request TSN channel access. Alternatively, the STA may also send the request in the non-TSN channel(s).

At block 510, the device may determine the first device is authorized to access the first communication channel. For example, the AP may determine based on a channel access request received from the user device whether to allow the user device to transmit data on a TSN channel. For example the user device may utilize the operational information included in the IE that includes the TSN channel set field. The user device may further notify/inform the AP that the user device has TSN transmissions. The AP may utilize the information received from the user device in order to determine whether to allow the user device to utilize the dedicated TSN channel based at least in part on the information received from the user device. If the AP determines that the user device is allowed to access the TSN channel, the AP may communicate with the user device using the dedicated TSN channel. However, if the AP determines that the user device is not allowed or authorized to access the TSN channel, the AP may assign a non-TSN channel to communicate with the user device. Further, the AP may also indicate that the device is not allowed to communicate in any dedicated TSN channels.

FIG. 5B illustrates a flow diagram of illustrative process 550 for a WTSN system, in accordance with one or more example embodiments of the present disclosure.

At block 552, a device (e.g., the user device(s) 120 and/or the AP 102 of FIG. 1) may identify a first frame received from a device. For example, a user device may receive a management frame from an AP. For example, using a beacon frame, the AP may include specific information associated with TSN channel allocations and/or operational information associated with accessing any of the TSN channel allocations. For example, the AP may utilize beacon frames and other control and/or management frames (e.g., announce frames, trigger frames, or any other frames). These frames may carry at least in part, a list of channels that are dedicated for TSN.

At block 554, the device may identify an information element (IE) included in the frame, wherein the IE is associated with a first communication channel assigned for time sensitive networking communications. The beacon frame may include an IE that may provide the user device with information specific to the TSN allocations. The IE may include at least in part, a TSN channel set field, which may include one or more TSN channel operational information fields. Each of the TSN channel operational information fields may include, at least in part, a channel width field, a channel center frequency field, a TSN MCS set field, and a TSN access parameters field. The TSN MCS set field may include the set of MCSs and spatial streams that may be used for TSN transmissions in a dedicated channel. That is, the AP may utilize the TSN MCS set field to announce to the STAs the set of MCSs and spatial streams in case the STAs have TSN data packets to transmit. The STAs would utilize that information when requesting access to the channel for TSN transmissions. The TSN access parameters field may include at least in part, specific MAC access mode. The MAC access modes may include but not limited to, a scheduled mode where the AP assigns one or more time (or frequency) slots to be used by one or more devices, a contention mode, where the AP does not assign one or more time (or frequency) slots for one or more devices. Instead, the time or frequency slots are taken by contention based mechanism. Further, the MAC access mode may include a polled mode, where the AP may send a poll request inquiring if the user device has data to send in the uplink direction.

At block 556, the device may cause to send a second frame to another device based at least in part on the IE. For example, a user device may send a frame to the AP based at least on the information contained in the IE found in the received beacon frame. The user device may have TSN data packets that may require TSN transmissions. Since TSN transmissions require low latency and guaranteed transmissions, the user device may send a TSN channel access request to the AP indicating that it has TSN data packets requiring a dedicated TSN channel. The AP may respond to the user device based on the information included in the TSN channel request whether the AP authorizes the user device to access a TSN channel. The AP may deny the user device access to the TSN channel if the AP determines that the user device does not have TSN related data packets. In that case, the AP may assign the user device to other non-TSN channels to transmit its data. It is understood that the above descriptions are for purposes of illustration and are not meant to be limiting.

FIG. 6 shows a functional diagram of an exemplary communication station 600 in accordance with some embodiments. In one embodiment, FIG. 6 illustrates a functional block diagram of a communication station that may be suitable for use as an AP 102 (FIG. 1) or a user device 120 (FIG. 1) in accordance with some embodiments. The communication station 600 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 600 may include communications circuitry 602 and a transceiver 610 for transmitting and receiving signals to and from other communication stations using one or more antennas 601. The communications circuitry 602 may include circuitry that can operate the physical layer (PHY) communications and/or media access control (MAC) communications for controlling access to the wireless medium, and/or any other communications layers for transmitting and receiving signals. The communication station 600 may also include processing circuitry 606 and memory 608 arranged to perform the operations described herein. In some embodiments, the communications circuitry 602 and the processing circuitry 606 may be configured to perform operations detailed in FIGS. 2, 3, 4, 5A and 5B.

In accordance with some embodiments, the communications circuitry 602 may be arranged to contend for a wireless medium and configure frames or packets for communicating over the wireless medium. The communications circuitry 602 may be arranged to transmit and receive signals. The communications circuitry 602 may also include circuitry for modulation/demodulation, upconversion/downconversion, filtering, amplification, etc. In some embodiments, the processing circuitry 606 of the communication station 600 may include one or more processors. In other embodiments, two or more antennas 601 may be coupled to the communications circuitry 602 arranged for sending and receiving signals. The memory 608 may store information for configuring the processing circuitry 606 to perform operations for configuring and transmitting message frames and performing the various operations described herein. The memory 608 may include any type of memory, including non-transitory memory, for storing information in a form readable by a machine (e.g., a computer). For example, the memory 608 may include a computer-readable storage device, read-only memory (ROM), random-access memory (RAM), magnetic disk storage media, optical storage media, flash-memory devices and other storage devices and media.

In some embodiments, the communication station 600 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 600 may include one or more antennas 601. The antennas 601 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 600 may include one or more of a keyboard, a display, a non-volatile memory port, multiple antennas, a graphics processor, an application processor, speakers, and other mobile device elements. The display may be an LCD screen including a touch screen.

Although the communication station 600 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 600 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 600 may include one or more processors and may be configured with instructions stored on a computer-readable storage device memory.

FIG. 7 illustrates a block diagram of an example of a machine 700 or system upon which any one or more of the techniques (e.g., methodologies) discussed herein may be performed. In other embodiments, the machine 700 may operate as a standalone device or may be connected (e.g., networked) to other machines. In a networked deployment, the machine 700 may operate in the capacity of a server machine, a client machine, or both in server-client network environments. In an example, the machine 700 may act as a peer machine in peer-to-peer (P2P) (or other distributed) network environments. The machine 700 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 700 may include a hardware processor 702 (e.g., a central processing unit (CPU), a graphics processing unit (GPU), a hardware processor core, or any combination thereof), a main memory 704 and a static memory 706, some or all of which may communicate with each other via an interlink (e.g., bus) 708. The machine 700 may further include a power management device 732, a graphics display device 710, an alphanumeric input device 712 (e.g., a keyboard), and a user interface (UI) navigation device 714 (e.g., a mouse). In an example, the graphics display device 710, alphanumeric input device 712, and UI navigation device 714 may be a touch screen display. The machine 700 may additionally include a storage device (i.e., drive unit) 716, a signal generation device 718 (e.g., a speaker), a WTSN device 719, a network interface device/transceiver 720 coupled to antenna(s) 730, and one or more sensors 728, such as a global positioning system (GPS) sensor, a compass, an accelerometer, or other sensor. The machine 700 may include an output controller 734, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)).

The storage device 716 may include a machine readable medium 722 on which is stored one or more sets of data structures or instructions 724 (e.g., software) embodying or utilized by any one or more of the techniques or functions described herein. The instructions 724 may also reside, completely or at least partially, within the main memory 704, within the static memory 706, or within the hardware processor 702 during execution thereof by the machine 700. In an example, one or any combination of the hardware processor 702, the main memory 704, the static memory 706, or the storage device 716 may constitute machine-readable media.

The WTSN device 719 may carry out or perform any of the operations and processes (e.g., processes 500 and 550) described and shown above. For example, the WTSN device 719 may be configured to restrict wireless devices from accessing a dedicated channel based at least in part on the type of application. The WTSN system may enable an AP to assign dedicated channel(s) to TSN applications including announcement of TSN dedicated channels and a procedure to prevent non-TSN transmissions in TSN dedicated channels. The AP may select a dedicated channel for TSN transmissions based on a combination of factors. Some of these factors may include channel measurements, the number of associated STAs, specific latency requirements. The WTSN system may define one or more access rules associated with dedicated channels. These one or more rules may be shared with the TSN devices and wireless devices. The WTSN system may enable an AP to advertise the assigned dedicated channels to one or more devices including a mix of TSN devices and wireless devices. The WTSN system may define an information element to be used in management frames, such as beacon frames, announce frames, trigger frames, or any other management frame. The information element may include TSN specific information. Given the deterministic nature of the most critical TSN flows (both packet size and inter-arrival times are known), by restricting access to a given channel to only TSN flows, it becomes possible to schedule TSN transmissions, provide redundancy, and avoid interference from other STAs.

It is understood that the above are only a subset of what the WTSN device 719 may be configured to perform and that other functions included throughout this disclosure may also be performed by the WTSN device 719.

While the machine-readable medium 722 is illustrated as a single medium, the term “machine-readable medium” may include a single medium or multiple media (e.g., a centralized or distributed database, and/or associated caches and servers) configured to store the one or more instructions 724.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 700 and that cause the machine 700 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 724 may further be transmitted or received over a communications network 726 using a transmission medium via the network interface device/transceiver 720 utilizing any one of a number of transfer protocols (e.g., frame relay, internet protocol (IP), transmission control protocol (TCP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 720 may include one or more physical jacks (e.g., Ethernet, coaxial, or phone jacks) or one or more antennas to connect to the communications network 726. In an example, the network interface device/transceiver 720 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 700 and includes digital or analog communications signals or other intangible media to facilitate communication of such software. The operations and processes (e.g., processes 500 and 550) described and shown above may be carried out or performed in any suitable order as desired in various implementations. Additionally, in certain implementations, at least a portion of the operations may be carried out in parallel. Furthermore, in certain implementations, less than or more than the operations described may be performed.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a single input single output (SISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

According to example embodiments of the disclosure, there may be a device. The device may include memory and processing circuitry, configured to determine one or more communication channels. The memory and processing circuitry may be further configured to assign a first communication channel of the one or more communication channels, for time sensitive networking. The memory and processing circuitry may be further configured to cause to send a frame including an indication of the first communication channel to one or more devices. The memory and processing circuitry may be further configured to identify a time sensitive networking channel access request from a first device. The memory and processing circuitry may be further configured to determine the first device is authorized to access the first communication channel.

The implementations may include one or more of the following features. The memory and the processing circuitry may be further configured to identify a non-time sensitive networking channel access request from a second device. The memory and processing circuitry may be further configured to assign a second communication channel of the one or more communication channels to the second device. The memory and processing circuitry may be further configured to deny the second device from accessing the first channel. The indication may include an information element (IE) associated with the first communication channel, the IE may include at least in part a time sensitive networking channel set. The time sensitive networking channel set may include at least one of a time sensitive modulations and coding scheme (MCS) set, or one or more time sensitive networking access parameters. The time sensitive networking MCS set may include one or more MCSs associated with time sensitive networking channels. The one or more time sensitive networking access parameters include at least in part, a data rate, a power level, or access parameters associated with the first communication channel. The memory and the processing circuitry may be further configured to cause to advertise one or more communication channels associated with time sensitive networking using one or more management frames. The one or more management frames include at least one of a beacon frame, an announce frame, or a trigger frame. The device may further include a transceiver configured to transmit and receive wireless signals. The device may further include one or more antennas coupled to the transceiver.

According to example embodiments of the disclosure, there may be a non-transitory computer-readable medium storing computer-executable instructions which, when executed by a processor, cause the processor to perform operations. The operations may include identifying a first frame received from a device. The operations may include identifying an information element (IE) included in the frame, wherein the IE is associated with a first communication channel assigned for time sensitive networking communications. The operations may include causing to send a second frame to the device based at least in part on the IE.

The implementations may include one or more of the following features. The second frame is associated with non-time sensitive networking channel request. The IE may include at least in part, a time sensitive networking channel set, the time sensitive networking channel set may include at least one of a time sensitive modulations and coding scheme (MCS) set, or one or more time sensitive networking access parameters. The operations further may include determining a third frame associated with time sensitive networking communications. The operations may include causing to send the third frame to the device using the first communication channel. The time sensitive networking MCS set may include one or more MCSs associated with time sensitive networking channel. The operations further may include identifying a medium access control (MAC) access mode, wherein the MAC access mode may include one of a scheduled access mode or a contention access mode.

According to example embodiments of the disclosure, there may include a method. The method may include determining, by one or more processors, one or more communication channels. The method may include assigning a first communication channel of the one or more communication channels, for time sensitive networking. The method may include causing to send a frame including an indication of the first communication channel to one or more devices. The method may include identifying a time sensitive networking channel access request from a first device. The method may include determining the first device is authorized to access the first communication channel.

The implementations may include one or more of the following features. The method may include identifying a non-time sensitive networking channel access request from a second device. The method may include assigning a second communication channel of the one or more communication channels to the second device. The method may include restricting the second device from accessing the first channel. The indication my include an information element (IE) associated with the first communication channel, the IE may include at least in part, a time sensitive networking channel set. The time sensitive networking channel set may include at least one of a time sensitive modulations and coding scheme (MCS) set, or time sensitive networking access parameters. The time sensitive networking MCS set may include one or more MCSs associated with time sensitive networking channels. The one or more time sensitive networking access parameters may include at least in part, a data rate, a power level, or access parameters associated with the first communication channel. The method may further include causing to advertise one or more communication channels associated with time sensitive networking using one or more management frames. The one or more management frames may include at least one of a beacon frame, an announce frame, or a trigger frame.

According to example embodiments of the disclosure, there may be a non-transitory computer-readable medium storing computer-executable instructions which, when executed by a processor, cause the processor to perform operations. The operations may include determining, by one or more processors, one or more communication channels. The operations may include assigning a first communication channel of the one or more communication channels, for time sensitive networking. The operations may include causing to send a frame including an indication of the first communication channel to one or more devices. The operations may include identifying a time sensitive networking channel access request from a first device. The operations may include

determining the first device is authorized to access the first communication channel.

The implementations may include one or more of the following features. The operations further may include identifying a non-time sensitive networking channel access request from a second device. The operations may include assigning a second communication channel of the one or more communication channels to the second device. The operations may include restricting the second device from accessing the first channel. The indication may include an information element (IE) associated with the first communication channel, the IE may include at least in part, a time sensitive networking channel set. The time sensitive networking channel set may include at least one of a time sensitive modulations and coding scheme (MCS) set, or time sensitive networking access parameters. The time sensitive networking MCS set may include one or more MCSs associated with time sensitive networking channels. The one or more time sensitive networking access parameters include at least in part, a data rate, a power level, or access parameters associated with the first communication channel. The operations further may include causing to advertise one or more communication channels associated with time sensitive networking using one or more management frames. The one or more management frames include at least one of a beacon frame, an announce frame, or a trigger frame.

In example embodiments of the disclosure, there may be an apparatus. The apparatus may include means for determining, by one or more processors, one or more communication channels. The apparatus may include means for assigning a first communication channel of the one or more communication channels, for time sensitive networking. The apparatus may include means for causing to send a frame including an indication of the first communication channel to one or more devices. The apparatus may include means for identifying a time sensitive networking channel access request from a first device. The apparatus may include means for determining the first device is authorized to access the first communication channel.

The implementations may include one or more of the following features. The apparatus may further include means for identifying a non-time sensitive networking channel access request from a second device. The apparatus may means for assigning a second communication channel of the one or more communication channels to the second device. The apparatus may means for restricting the second device from accessing the first channel. The indication includes an information element (IE) associated with the first communication channel, the IE includes at least in part, a time sensitive networking channel set. The time sensitive networking channel set includes at least one of a time sensitive modulations and coding scheme (MCS) set, or time sensitive networking access parameters. The time sensitive networking MCS set includes one or more MCSs associated with time sensitive networking channels. The one or more time sensitive networking access parameters include at least in part, a data rate, a power level, or access parameters associated with the first communication channel. The apparatus may further include means for causing to advertise one or more communication channels associated with time sensitive networking using one or more management frames. The one or more management frames include at least one of a beacon frame, an announce frame, or a trigger frame.

In example embodiments of the disclosure, there may be an apparatus. The apparatus may include means for identifying a first frame received from a device. The apparatus may include

means for identifying an information element (IE) included in the frame, wherein the IE is associated with a first communication channel assigned for time sensitive networking communications. The apparatus may include means for causing to send a second frame to the device based at least in part on the IE.

The implementations may include one or more of the following features. The second frame is associated with non-time sensitive networking channel request. The IE includes at least in part, a time sensitive networking channel set, the time sensitive networking channel set includes at least one of a time sensitive modulations and coding scheme (MCS) set, or one or more time sensitive networking access parameters. The apparatus may include means for determining a third frame associated with time sensitive networking communications. The apparatus may include means for causing to send the third frame to the device using the first communication channel. The time sensitive networking MCS set includes one or more MCSs associated with time sensitive networking channel. The apparatus may include means for identifying a medium access control (MAC) access mode, wherein the MAC access mode includes one of a scheduled access mode or a contention access mode. An apparatus may include means for performing a method as claimed in any of the preceding claims.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising memory and processing circuitry, configured to:
determine one or more communication channels;
assign a first communication channel of the one or more communication channels, for time sensitive networking;
cause to send a frame including an indication of the first communication channel to one or more devices;
identify a time sensitive networking channel access request from a first device; and
determine the first device is authorized to access the first communication channel.

2. The device of claim 1, wherein the memory and the processing circuitry is further configured to:
identify a non-time sensitive networking channel access request from a second device;
assign a second communication channel of the one or more communication channels to the second device; and
restrict the second device from accessing the first channel.

3. The device of claim 1, wherein the indication includes an information element (IE) associated with the first communication channel, the IE includes at least in part, a time sensitive networking channel set.

4. The device of claim 3, wherein the time sensitive networking channel set includes at least one of a time sensitive modulations and coding scheme (MCS) set, or time sensitive networking access parameters.

5. The device of claim 4, wherein the time sensitive networking MCS set includes one or more MCSs associated with the time sensitive networking channels.

6. The device of claim 4, wherein the time sensitive networking access parameters include at least in part, a data rate, a power level, or access parameters associated with the first communication channel.

7. The device of claim 1, wherein the memory and the processing circuitry is further configured to:
cause to advertise one or more communication channels associated with time sensitive networking using one or more management frames; and

8. The device of claim 7, wherein the one or more management frames includes at least one of a beacon frame, an announce frame, or a trigger frame.

9. The device of claim 1, further comprising a transceiver configured to transmit and receive wireless signals.

10. The device of claim 9, further comprising one or more antennas coupled to the transceiver.

11. A non-transitory computer-readable medium storing computer-executable instructions which when executed by one or more processors result in performing operations comprising:
identifying a first frame received from a device;
identifying an information element (IE) included in the frame, wherein the IE is associated with a first communication channel assigned for time sensitive networking communications; and
causing to send a second frame to the device based at least in part on the IE.

12. The non-transitory computer-readable medium of claim 11, wherein the second frame is associated with non-time sensitive networking channel request.

13. The non-transitory computer-readable medium of claim 11, wherein the IE includes at least in part, a time sensitive networking channel set, the time sensitive networking channel set includes at least one of a time sensitive modulations and coding scheme (MCS) set, or time sensitive networking access parameters.

14. The non-transitory computer-readable medium of claim 11, wherein the operations further comprising:
determining a third frame associated with time sensitive networking communications; and
causing to send the third frame to the device using the first communication channel.

15. The non-transitory computer-readable medium of claim 13 wherein the time sensitive networking MCS set includes one or more MCSs associated with the time sensitive networking channels.

16. The non-transitory computer-readable medium of claim 11, wherein the operations further comprising:
identifying a medium access control (MAC) access mode, wherein the Mac access mode includes one of a scheduled access mode or a contention access mode.

17. A method comprising:
determining, by one or more processors, one or more communication channels;
assigning a first communication channel of the one or more communication channels, for time sensitive networking;
causing to send a frame including an indication of the first communication channel to one or more devices;
identifying a time sensitive networking channel access request from a first device; and
determining the first device is authorized to access the first communication channel.

18. The method of claim 17, further comprising:
identify a non-time sensitive networking channel access request from a second device;
assign a second communication channel of the one or more communication channels to the second device; and
restrict the second device from accessing the first channel.

19. The method of claim 17, wherein the indication includes an information element (IE) associated with the first communication channel, the IE includes at least in part, a time sensitive networking channel set.

20. The method of claim 19, wherein the time sensitive networking channel set includes at least one of a time sensitive modulations and coding scheme (MCS) set, or time sensitive networking access parameters.
